(19) United States
(12) Patent Application Publication
(10) Pub. No.: US 2013/0085960 A1
(43) Pub. Date: Apr. 4, 2013

(54) Value Articulation of a Business Service

(71) Applicants: Doji Samson Lokku, Hyderabad (IN); Ankan Kumar Sen, Hyderabad (IN); Mandaleeka Guru Prasada Lakshmi Narayana, Hyderabad (IN)

(72) Inventors: Doji Samson Lokku, Hyderabad (IN); Ankan Kumar Sen, Hyderabad (IN); Mandaleeka Guru Prasada Lakshmi Narayana, Hyderabad (IN)

(73) Assignee: TATA CONSULTANCY SERVICES LIMITED, Mumbai (IN)

(21) Appl. No.: 13/280,065

(22) Filed: Oct. 24, 2011

Related U.S. Application Data
(60) Provisional application No. 61/541,702, filed on Sep. 30, 2011.

(51) Int. Cl. G06Q 99/00

(52) U.S. Cl. 705/348

(57) ABSTRACT

The present subject matter relates to a method for value articulation of a business service. In one embodiment, the method includes receiving input data associated with the business service. The method further includes generating a value articulation matrix having at least four dimensions such that each of the dimensions comprise elements selected from the input data. In said embodiment, a stakeholder dimension includes one or more elements indicative of stakeholders associated with the business service, an offering dimension includes one or more elements indicative of offerings of the business service, an enablement dimension includes one or more elements indicative of enablements possible due to the business service, and a benefit dimension includes one or more elements indicative of benefits associated with the business service.

### CROSS-REFERENCE TO RELATED U.S. PATENT APPLICATION

The present application claims priority under 35 U.S.C. §119(e) to U.S. Provisional Patent Application Ser. No. 61/541,702, entitled “VALUE ARTICULATION OF A BUSINESS SERVICE,” which was filed on Sep. 30, 2011.

### TECHNICAL FIELD

The present subject matter, in general, relates to value articulation, and in particular, to value articulation of a business service.

### BACKGROUND

In a typical business scenario, service providers, such as service providers in the information technology (IT) industry, telecom industry, etc. provide business services to their clients. Sometimes investments made towards the business services may not deliver the business returns as expected by the clients. Therefore, the clients generally prefer ensuring in advance the benefits of such investments. In other words, selling the business services to the clients can be a difficult task since it may involve convincing the clients about the returns of their investments.

If the service providers can identify and highlight the unique value of the business services that they may be proposing to their clients, then it becomes easier for the clients to review the business returns of engagement with the service providers. Moreover, the clients and the service providers both are well-positioned to justify the value of the business service in clear measurable terms. Thus, a clearly articulated value can allow the clients to examine the returns of their investments and may help dispel misconceptions and facilitate effective engagement between the clients and the service providers.

### SUMMARY

This summary is provided to introduce concepts related to value articulation of a business service. These concepts are further described below in the detailed description. This summary is not intended to identify essential features of the claimed subject matter nor is it intended for use in determining or limiting the scope of the claimed subject matter.

In an embodiment of the present subject matter, a method for value articulation of a business service. The method includes receiving input data associated with the business service. The method further includes generating a value articulation matrix having at least four dimensions. Each of the dimensions comprises elements selected from amongst the input data. In said embodiment, a stakeholder dimension includes one or more elements from amongst the input data that are indicative of stakeholders associated with the business service, an offering dimension includes one or more elements from amongst the input data that are indicative of offerings of the business service, an enablement dimension includes one or more elements from amongst the input data that are indicative of enablements possible due to the business service, and a benefit dimension includes one or more elements from amongst the input data that are indicative of benefits associated with the business service.

These and other features, aspects, and advantages of the present subject matter will be better understood with reference to the following description and appended claims. This summary is provided to introduce a selection of concepts in a simplified form. This summary is not intended to identify key features or essential features of the claimed subject matter, nor is it intended to be used to limit the scope of the claimed subject matter.

### BRIEF DESCRIPTION OF THE DRAWINGS

The above and other features, aspects, and advantages of the subject matter will be better understood with regard to the following description, appended claims, and accompanying drawings, where:

FIG. 1 illustrates an exemplary method for value articulation of a business service, according to an embodiment of the present subject matter.

FIG. 2 illustrates an exemplary value articulation matrix, according to an embodiment of the present subject matter.

FIG. 3 illustrates an exemplary system for value articulation of a business service, according to an embodiment of the present subject matter.

### DETAILED DESCRIPTION

The present subject matter relates to value articulation of a business service. In the present description, the term “business service” is intended to include any business product including solutions, consultancy, etc. Typically, service providers, such as IT companies, provide various business services to their clients. Selling the business services becomes easier if the service providers are able to precisely articulate the value of their business services in some clear and measurable terms. There could be several ways of describing the value. Such a description of the value may also be referred to as value articulation.

According to the present subject matter, the value is considered to be in the eye of the clients. In that respect, the value can be defined as the net-benefits delivered or proposed to the clients through an offering. The offering may be considered a particular feature of a business service. Accordingly, the business service includes multiple offerings. In addition, the value can also be defined as the worth of the offering, as perceived by the clients. The assumption in the above definition is that the offering is the carrier of the value. For example, a typical communication system may be considered. Noise level in the communication system may be considered as the quality characteristic and clarity of communication may be considered the value. It is the noise level in the communication system decides the clarity of communication, i.e., it is the quality characteristics of the offering that ultimately translate into the value.

In view of the above definition of the value, the present subject matter describes methods and systems for value articulation of a business service. The underlying basis for these methods and systems is a value articulation matrix that enables a systematic value articulation of the business service.

According to an embodiment of the present subject matter, a method for value articulation of a business service includes receiving input data associated with the business service. The input data may comprise a plurality of elements such as stakeholders or benefits associated with a business service. The method further includes generating a value articulation matrix having at least four dimensions. Each of the at least four dimensions comprises elements selected from amongst the input data, which when put together, capture the value of the business services in a comprehensive and complete manner.

In said embodiment, a stakeholder dimension includes one or more elements indicative of stakeholders or value statements associated with the business service. A stakeholder is a person who would possibly appreciate the value of the business service. A value statement represents a value of the business service formulated by a perspective of the stakeholders. Examples of the one or more elements of stakeholder dimension include managers, officers, etc. or their perspective of the value of the business service in the form of value statements.

In said embodiment, an offering dimension includes one or more elements indicative of offerings of the business service. Here an offering is the carrier of the value and is defined in terms of aspects or characteristics of the business service. Examples of the one or more elements of the offering dimension include various functional modules of the business service.

In said embodiment, an enablement dimension includes one or more elements indicative of enablements possible due to the business service. Here an enablement describes what the offering can possibly bring in client's business. Examples of the one or more elements of the enablement dimension include tasks that a stakeholder is able to do via offerings of the business service.

In said embodiment, a benefit dimension includes one or more elements indicative of benefits or values associated with the business service. Here a benefit describes the net-benefits that would possibly accrue to a given stakeholder. Examples of the one or more elements of the benefit dimension include the tangible as well as intangible benefits, such as increased productivity, increased sales, and better work culture.

For example, an IT service provider may offer an accounting system to a financial institution, such as a bank. The IT service provider can prepare the value articulation matrix, according to the present subject matter, to articulate the value that the offerings, which in this example are features of the accounting system, will bring to the bank. Firstly, the input data associated with the business service is determined. The input data includes list of the stakeholders of the accounting system, the features of accounting system, enablements from the accounting system, and the benefits of the accounting systems. As described earlier, the value articulation matrix includes four dimensions generated based on the input data. The first dimension is the stakeholder dimension. It includes mangers, officers, support staff, etc. who may use the accounting system, or their perspective of the value of the accounting system in the form of value statements. The second dimension is the offering dimension. The second dimension includes different features of the accounting system, such as accounting, billing, loan, audit, etc. The third dimension is the enablement dimension. The third dimension includes the enablements that stakeholders may be able to do because of the offerings. Examples of enablements may include utilizing templates for different functions, predefining different processes, enabling backups, etc. The fourth dimension is the benefit dimension. It includes the benefits, such as increased productivity or time savings, as realized by the bank from the accounting system. This value articulation matrix may help the IT service provider to explain the bank in a systematic manner what exactly are the benefits of the accounting system.

The present subject matter describes in detail the above mentioned specific dimensions of the value articulation matrix. The value articulation matrix with its four dimensions when put together enables service providers to articulate the value of their services in a systematic, uniform, and consistent manner. Such systematic articulation of the value of the services is more acceptable to the clients and also enhances the position of the service providers with regard to communication and negotiation with the clients.

The value articulation matrix orients the thought process of value articulators, whereas in the absence of this value articulation matrix, the effort to articulate value can be adhoc, without focus, and incomplete. In addition, this value articulation matrix facilitates preparation of reports, identification of gaps, and preparation for client meetings. Moreover, this value articulation matrix has the advantage of including more elements in the dimensions, i.e., the value articulation matrix possess the flexibility to expand and correct as and when the elements of various dimensions are captured. The value articulation matrix allows one to know clearly a start and an end of articulating value of a business service. Additionally, the value articulation matrix gives rise to elaborate value articulations that can be categorized as needed.

These and other advantages of the present subject matter would be described in greater detail in conjunction with the following figures. While aspects of described systems and methods for value articulation of a business service can be implemented in any number of different computing devices, the embodiments are described in the context of the following exemplary method(s).

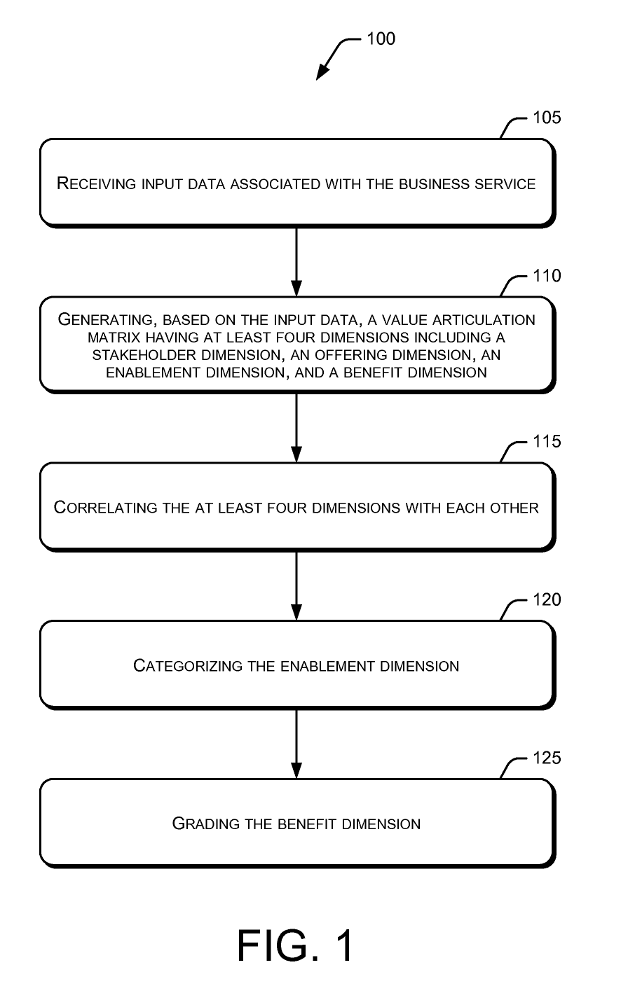

FIG. 1 illustrates an exemplary method 100 for value articulation of a business service, in accordance with an embodiment of the present subject matter. The exemplary method may be described in the general context of computer executable instructions. Generally, computer executable instructions can include routines, programs, objects, components, data structures, procedures, modules, functions, etc., that perform particular functions or implement particular abstract data types. The method may also be practiced in a distributed computing environment where functions are performed by remote processing devices that are linked through a communications network. In a distributed computing environment, computer executable instructions may be located in both local and remote computer storage media, including memory storage devices.

The order in which the method are described is not intended to be construed as a limitation, and any number of the described method blocks can be combined in any order to implement the method, or an alternative method. Additionally, individual blocks may be deleted from the method without departing from the spirit and scope of the subject matter described herein. Furthermore, the method can be implemented in any suitable hardware, software, firmware, or combination thereof. Each block of the method 100 for value articulation of a business service is described below in detail.

At block 105, input data associated with the business service is received. In one embodiment, the input data includes list of the stakeholders of the business service, the features of business service, enablements from the business service, and the benefits of the business service.

At block 110, a value articulation matrix having four dimensions is generated based on the input data. In one embodiment, the four dimensions include one dimension for stakeholders or value statements, one dimension for offerings, one dimension for enablements, and one dimension for benefits. In an embodiment, these four dimensions may form the value articulation matrix in any possible sequence. These four dimensions are described below in detail.

### Dimension for Stakeholders

In cases where one is able to articulate a compelling value of the business services and solutions, but not able to identify the person to sell it to, the articulated value may be of no worth because there is no one who would appreciate the articulated value. Since it is only people who can appreciate the value of business service or solution, the starting point for value articulation is the identification of stakeholders. A stakeholder of a business service is defined as any person who is affected because of the business service. Typically, a client is the usual stakeholder. Additionally, the stakeholders can also include project sponsors, investors, owners, users, system designers, developers, and so on. Accordingly, a list of all such stakeholders forms the first dimension of the value articulation matrix.

### Dimension for Value Statements

Alternatively, in place of the stakeholder dimension, the perception of value by the stakeholders can also form the first dimension of the value articulation matrix. The idea is to match with the stakeholder's perception of value in order to deliver the value to client. From the understanding gathered about the client, the client's perception of value in the form of value statements may be determined.

### Dimension for Offerings

Since the carrier for value is an offering made to a client, the description of the offerings in terms of its features, aspects, properties, modules, etc. forms the second dimension of the value articulation matrix. The offerings are the business services or solutions that service providers bring to the table in anticipation that the client would derive value out of them. In a sense, in the absence of an offering, value can not accrue to a client, as there is no media for transaction and hence no transaction may take place. Having identified the stakeholders who would possibly appreciate the value, the next task may be to describe the offering in terms of quality characteristics, which would supposedly carry value to the stakeholder.

### Dimension for Enablements

Having the offerings in hand is different from deriving value out of it. In this sense, unless the offering is put to use by the clients, it is not possible to experience value out of it. In an example, where the offering is a service, the value is directly experienced by the client as the services are rendered or delivered by the service providers. The aspects or characteristics of the offering translate to value, that may be experienced by the clients. Since technology is seen as an enabler, in a situation where the offering is a technology-based solution or the offering relates to a technology-based solution, the enablement itself can be perceived as the potential value. In this sense, the enablement that is brought to the clients through the offerings and can be described in an elaborate manner and it forms the third dimension of the value articulation matrix.

### Dimension for Benefits

Lastly, the benefits, i.e., values that accrue to the client because of the enablements that are brought to the clients through the offerings, form the fourth dimension of the value articulation matrix. The benefits could be tangible as well as intangible benefits. The value articulation can be undertaken, having delivered a solution and hence it may be called value delivered or value reported. Otherwise, it can happen prior to delivering a solution, for example, while proposing a solution to a client and hence it may be called value proposition. Both are articulations and hence they are the descriptions of the value. In an embodiment, if the benefits are quantitative in numbers, for example, sales, then only the netted out portion of the benefits belongs to the value, such as increases in the sales from the business service.

At block 115, the four dimensions are correlated with each other. To correlate the four dimensions, the elements of one dimension are mapped with the elements of adjacent dimension. An arrow, cross, any other symbol, or any mapping scheme may be used to map the elements of two dimensions. For example, a link between a given enablement with the aspects or characteristics of the offering can be established through the value articulation matrix or the enablements can be linked to the name of the stakeholder to whom it may possibly make sense.

At block 120, the elements of the enablement dimension are categorized. The elements of enablements associated with the offerings are categorized as standard, customized, and superior enablement in order to highlight the selling points of the business services. In one example, the elements of enablements categorized as standard enablement represent the usual or normally expected enablements that are enabled from the business service. While the elements categorized as customized enablement represent the specially requested enablements from the business service. Similarly, the elements categorized as superior enablement represent unexpected enablements or enablements leading to greater values.

At block 125, the elements of the benefit dimensions are graded. In one embodiment, the elements of the benefit dimension are graded as smaller, average, and greater value to indicate the compelling values out of multiple values accrued from the business service. Only with such compelling values can one make claims regarding the value actually brought to the clients via the business service. The value articulation matrix enables the service providers to systematically arrive at elaborated value articulations, out of which only a few of them would possibly qualify towards value that any one would readily agree with.

In one embodiment, multiple value articulation matrixes can be created in cases where multiple or complex business services or solutions are delivered or proposed to the clients. In said embodiment, the value matrixes can be simply merged together dimension-wise in order to produce a combined value articulation matrix. In said embodiment, one can avail advantage of presenting the value of complex business services in a simple, but effective manner.

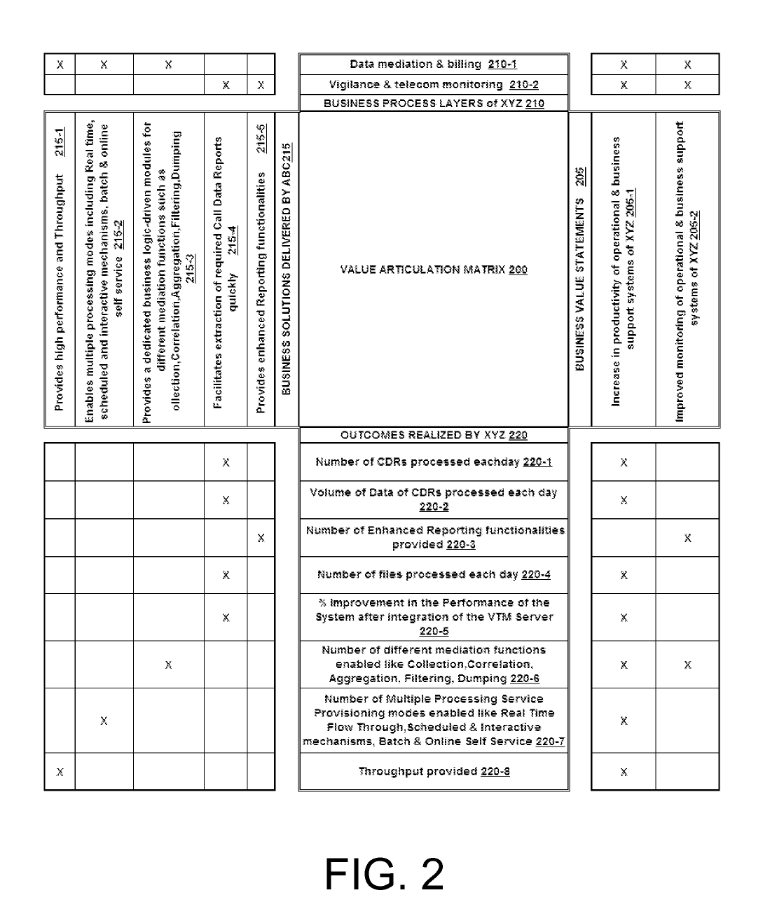

FIG. 2 illustrates an exemplary value articulation matrix 200, according to an embodiment of the present subject matter. To discuss the example depicted in FIG. 2, a service provider, for example, an organization by the name ABC, may be considered to be providing business solution to a client, for example, an organization by the name XYZ. The value articulation matrix 200 is generated for the value articulation of business solutions provided to XYZ by ABC. The value articulation matrix 200 includes four dimensions, which are as follows: business value statements 205; business process layers of XYZ 210; business solutions delivered by ABC 215; and outcomes realized by XYZ 220.

The business value statements 205 correspond to the stakeholder dimension or value statement dimension discussed earlier. It provides stakeholder's perspective of the value of the business solution offered by ABC. The business value statements 205 include two elements: increase in productivity of operational & business support systems of XYZ 205-1; and improved monitoring of operational & business support systems of XYZ 205-2.

The business process layers of XYZ 210 correspond to offering dimension discussed earlier. It provides the offerings by ABC that carry the value of business solution to XYZ. The business process layers of XYZ 210 include two elements: data mediation & billing 210-1; and vigilance & telecom monitoring 210-2. These are the modules of the business solution delivered by ABC to XYZ.

The business solutions delivered by ABC 215 correspond to the enablement dimension discussed earlier. It provides the enablements delivered to XYZ via ABC's business solution. The business solutions delivered by ABC 215 enable the following elements: provides high performance and throughput 215-1; enables multiple processing modes including real time, scheduled & interactive mechanisms, batch & online self service 215-2; provides a dedicated business logic-driven modules for different mediation functions such as collection, correlation, aggregation, filtering, dumping 215-3; facilitates extraction of required call data reports quickly 215-4; and provides enhanced reporting functionalities 215-5.

The outcomes realized by XYZ 220 correspond to the benefit dimension discussed earlier. It provides the tangible as well as intangible benefits accrued due to the business solution delivered by ABC. The outcomes realized by XYZ 220 include the following elements: number of CDRs processed each day 220-1; volume of data of CDRs processed each day 220-2; number of enhanced reporting functionalities provided 220-3; number of files processed each day 220-4; percentage improvement in the performance of the system after integration of the VTM server 220-5; number of different mediation functions enabled like collection, correlation, aggregation, filtering, & dumping 220-6; number of multiple processing service provisioning modes enabled like real time flow through, scheduled & interactive mechanisms, batch & online self service 220-7; and throughput provided 220-8.

Once the value articulation matrix 200 is generated, then the four dimensions of the value articulation matrix 200 are correlated with each other. In one example, the dimensions are correlated with each other using element wise mapping as shown in the FIG. 2. In said example, the elements of one dimensions are mapped to the elements of other dimensions using an ‘x’ symbol. It should be appreciated here that any other type of known mapping scheme can also be utilized to correlate the dimensions with each other.

With reference to the FIG. 2, consider the first value statement, which is ‘increase in productivity of operational & business support systems of XYZ’ 205-1. This value statement is carried by the both business process layers 210-1 and 210-2. In other words, both offerings of ABC, i.e., data mediation & billing 210-1, and vigilance & telecom monitoring 210-2 collectively help XYZ to realize the first value statement 205-1. It can be seen from FIG. 2 that the first offering 210-1 enables the first three enablements 215-1, 215-2, and 215-3, whereas the second offering 210-2 enables the last two enablements 215-4 and 215-5. Each of the various enablements 215 achieves one or more benefits or outcomes 220. For example, the first enablement, i.e., ‘provides high performance and throughput’ 215-1 achieves the last outcome, i.e., ‘throughput provided’ 220-8 which is linked with the first value statement 205-1. In this way, the elements of the various dimensions of the value articulation matrix 200 may be correlated. The correlation enables the clients to review the returns of their investments and thus facilitates effective engagement between the clients and the service providers.

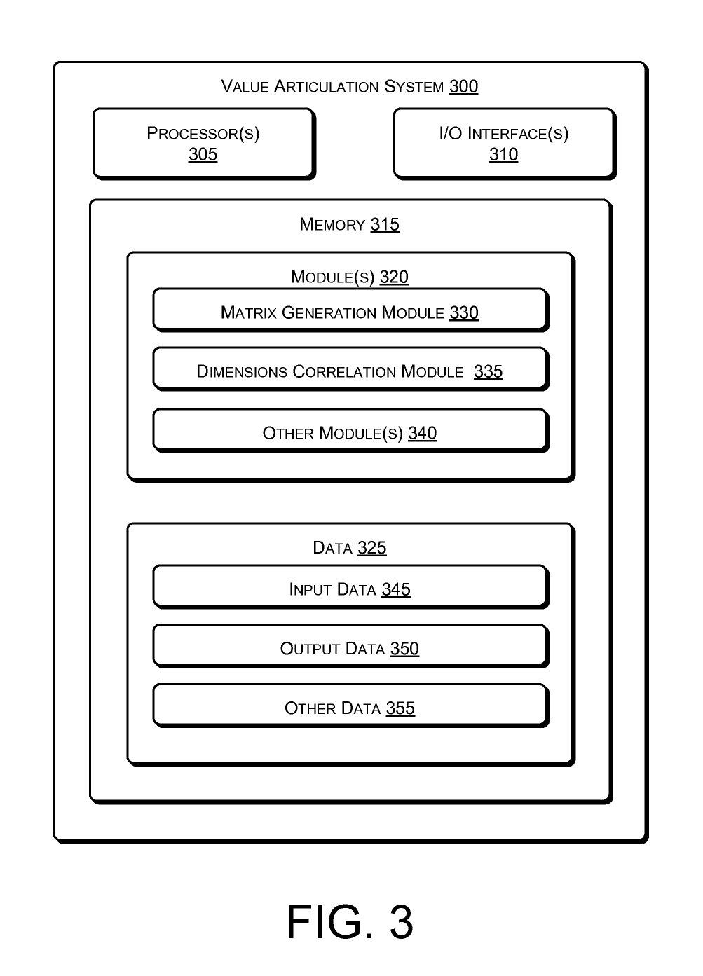

FIG. 3 illustrates an exemplary system 300 for value articulation of a business service, according to an embodiment of the present subject matter. In said embodiment, the system 300 includes a processor(s) 305, input-output (I/O) interface(s) 310, and a memory 315. The processor(s) 305 is coupled to the memory 315.

The processor(s) 305 may be implemented as one or more microprocessors, microcomputers, microcontrollers, digital signal processors, central processing units, state machines, logic circuitries, and/or any devices that manipulate signals based on operational instructions. Among other capabilities, the processor(s) 305 are configured to fetch and execute computer-readable instructions stored in the memory 315.

The I/O interface(s) 310 may include a variety of software and hardware interfaces, for example, a web interface allowing users to interact with the system 300. Further, the I/O interface(s) 310 may enable the system 300 to communicate with other computing devices, such as web servers, application servers, and external repositories. The I/O interface(s) 310 can facilitate multiple communications within a wide variety of networks and protocol types, including wired networks, for example LAN, cable, etc., and wireless networks such as WLAN, cellular, or satellite. The I/O interface(s) 310 may include one or more ports for connecting a number of computing devices to each other or to another server.

The memory 315 may include any computer-readable medium known in the art including, for example, volatile memory (e.g., RAM), and/or non-volatile memory (e.g., EPROM, flash memory, etc.). The memory 315 includes modules 320 and data 325. In an embodiment, the modules 320 include a matrix generation module 330, a dimensions correlation module 335, and other modules 340. The other module(s) 340 may include programs or coded instructions that supplement applications and functions of the system 300.

The data 325 serves, amongst other things, as a repository for storing data received, processed, and generated by one or more of the program module(s) 320. The data 325 can include input data 345, output data 350, and other data 355. The input data 345 stores the input data, such as the elements of various dimensions, received by the matrix generation module 330. On the other hand, the output data 350 stores the output data, such as the value articulation matrix generated by the matrix generation module 330 based on the input data 345. Lastly, the other data 355 includes data generated as a result of the execution of one or more instructions by the other module(s) 340.

In an embodiment, the matrix generation module 330 is configured to receive input data and generate a value articulation matrix having at least four dimensions based on the input data. In said embodiment, a stakeholder dimension includes one or more elements indicative of stakeholders associated with the business service, an offering dimension includes one or more elements indicative of offerings of the business service, an enablement dimension includes one or more elements indicative of enablements possible due to the business service, and a benefit dimension includes one or more elements indicative of benefits associated with the business service.

In an embodiment, the dimensions correlation module 335 is configured to correlate the dimensions with each other. To correlate the dimensions, the elements of one dimension are mapped with the elements of other dimension. An arrow, cross, or any other symbol may be used to map the elements of two lists. In an embodiment, the dimensions correlation module is further configured to assign codes for categorizing the one or more elements of the at least four dimensions. Any known coding scheme, such as color coding, may be utilized for the same.

Although implementations for methods and systems for value articulation of business services have been described in language specific to structural features and/or methods, it is to be understood that the appended claims are not necessarily limited to the specific features or methods described. Rather, the specific features and methods are disclosed as exemplary implementations for the value articulation of the business services.

1. A method for value articulation of a business service, the method comprising:
receiving input data associated with the business service; and
generating a value articulation matrix having at least four dimensions, each of the at least four dimensions comprising elements selected from the input data, wherein the at least four dimensions comprising a stakeholder dimension comprising one or more elements indicative of stakeholders associated with the business service, an offering dimension comprising one or more elements indicative of offerings of the business service, an enablement dimension comprising one or more elements indicative of at least one enablement provided by the business service, and a benefit dimension comprising one or more elements indicative of benefits associated with the business service.

2. The method of claim 1, wherein each of the one or more elements indicative of the stakeholders associated with the business service comprises users of the business service.

3. The method of claim 1, wherein each of the one or more elements indicative of the stakeholders associated with the business service comprises value statements, wherein each of the value statements is indicative of a value of the business service formulated form a perspective of the stakeholders associated with the business service.

4. The method of claim 1, further comprising correlating the at least four dimensions with each other.

5. The method of claim 4, wherein the correlating comprises mapping the one or more elements of one of the at least four dimensions with the one or more elements of an adjacent dimension in the value articulation matrix.

6. The method of claim 1, further comprising categorizing the one or more elements of the enablement dimension into a plurality of predetermined categories.

7. The method of claim 6, wherein the plurality of predetermined categories comprises a standard enablement, a customized enablement, and a superior enablement.

8. The method of claim 1, further comprising grading the one or more elements of the benefit dimension into a plurality of predetermined grades.

9. The method of claim 8, wherein the plurality of predetermined grades comprises a smaller value, an average value, and a greater value.

10. The method of claim 1, wherein the benefit dimension comprises values proposed for the business service.

11. The method of claim 1, wherein the benefit dimension comprises values delivered by the business service.

12. The method of claim 1, wherein the benefit dimension comprises tangible benefits of the business service.

13. The method of claim 1, wherein the benefit dimension comprises intangible benefits of the business service.

14. A system for value articulation of a business service, the system comprising:
a processor; and
a memory coupled to the processor, the memory comprising,
a matrix generation module configured to receive input data and generate, based on the input data, a value articulation matrix having at least four dimensions, wherein the at least four dimensions comprising a stakeholder dimension comprising one or more elements indicative of stakeholders associated with the business service, an offering dimension comprising one or more elements indicative of offerings of the business service, an enablement dimension comprising one or more elements indicative of enablements possible due to the business service, and a benefit dimension comprising one or more elements indicative of benefits associated with the business service.

15. The system of claim 14, wherein the memory further comprising a dimensions correlation module configured to correlate the at least four dimensions with each other.

16. The system of claim 14, wherein the input data comprises one or more elements of each of the at least four dimensions.

17. The system of claim 14, wherein the value articulation matrix includes a coding scheme for categorizing the one or more elements of the at least four dimensions.

18. A computer readable medium having embodied thereon a computer program for executing a method for value articulation a business service, the method comprising:
receiving input data associated with the business service;
generating a value articulation matrix having at least four dimensions, each of the at least four dimensions comprising elements selected from amongst the input data, wherein the at least four dimensions comprising a stakeholder dimension comprising one or more elements indicative of stakeholders associated with the business service, an offering dimension comprising one or more elements indicative of offerings of the business service, an enablement dimension comprising one or more elements indicative of at least one enablement provided by the business service, and a benefit dimension comprising one or more elements indicative of benefits associated with the business service; and
correlating the at least four dimensions with each other using a mapping scheme.

19. The computer readable medium of claim 18, wherein the value articulation matrix comprises a merger of a plurality of small value articulation matrixes.

20. The computer readable medium of claim 18, wherein the one or more elements are indicative of benefits comprises a contributing portion of quantitative benefits.
